(19) United States
(12) Patent Application Publication
(10) Pub. No.: US 2004/0125228 A1
(43) Pub. Date: Jul. 1, 2004

(54) Apparatus and method for determining the range of remote objects

(76) Inventor: Robert Dougherty, Bellevue, WA (US)

Correspondence Address: Gary C Cohn, Suite 105, 4010 Lake Washington Boulevard NE, Kirkland, WA, 98033, US

(21) Appl. No.: 10/333,423

(22) PCT Filed: Jul. 25, 2001
(86) PCT No.: PCT/US01/23535

(51) Int. Cl. H04N 5/225

(52) U.S. Cl. 348/345

(57) ABSTRACT

Range estimates are made using a passive technique. Light is focussed and then split into multiple beams. These beams are projected onto multiple image sensors, each of which is located at a different optical path length from the focussing system. By measuring the degree to which point objects are blurred on at least two of the image sensors, information is obtained that permits the calculation of the ranges of objects within the field of view of the camera. A unique beamsplitting system permits multiple, substantially identical images to be projected onto multiple image sensors using minimal overall physical distances, thus minimizing the size and weight of the camera. This invention permits ranges to be calculated continuously and in real time, and is suitable for measuring the ranges of objects in both static and nonstatic situations.

### BACKGROUND OF THE INVENTION

The present invention relates to apparatus and methods for optical image acquisition and analysis. In particular, it relates to passive techniques for measuring the range of objects.

In many fields such as robotics, autonomous land vehicle navigation, surveying and virtual reality modeling, it is desirable to rapidly measure the locations of all of the visible objects in a scene in three dimensions. Conventional passive image acquisition and processing techniques are effective for determining the bearings of objects, but do not adequately provide range information.

Various active techniques are used for determining the range of objects, including radar, sonar, scanned laser and structured light methods. These techniques all involve transmitting energy to the object and monitoring the reflection of that energy. These methods have several shortcomings. They often fail when the object does not reflect the transmitted energy well or when the ambient energies are too high. Production of the transmitted energy requires special hardware that consumes power and is often expensive and failure prone. When several systems are operating in close proximity, the possibility of mutual interference exists. Scanned systems can be slow. Sonar is prone to errors caused by wind. Most of these active systems do not produce enough information to identify objects.

Range information can be obtained using a conventional camera, if the object or the camera is moving a known way. The motion of the image in the field of view is compared with motion expected for various ranges in order to infer the range. However, the method is useful only in limited circumstances.

Other approaches make use of passive optical techniques. These generally break down into stereo and focus methods. Stereo methods mimic human stereoscopic vision, using images from two cameras to estimate range. Stereo methods can be very effective, but they suffer from a problem in aligning parts of images from the two cameras. In cluttered or repetitive scenes, such as those containing soil or vegetation, the problem of determining which parts of the images from the two cameras to align with each other can be intractable. Image features such as edges that are coplanar with the line segment connecting the two lenses cannot be used for stereo ranging.

Focus techniques can be divided into autofocus systems and range mapping systems. Autofocus systems are used to focus cameras at one or a few points in the field of view. They measure the degree of blur at these points and drive the lens focus mechanism until the blur is minimized. While these can be quite sophisticated, they do not produce point-by-point range mapping information that is needed in some applications.

In focus-based range mapping systems, multiple cameras or multiple settings of a single camera are used to make several images of the same scene with differing focus qualities. Sharpness is measured across the images and point-by-point comparison of the sharpness between the images is made in a way that effect of the scene contrast cancels out. The remaining differences in sharpness indicate the distance of the objects at the various points in the images.

The pioneering work in this field is a paper by Pentland. He describes a range mapping system using two or more cameras with differing apertures to obtain simultaneous images. A bulky beamsplitter/mirror apparatus is placed in front of the cameras to ensure that they have the same view of the scene. This multiple camera system is too costly, heavy, and limited in power to find widespread use.

In U.S. Pat. No. 5,365,597, Holeva describes a system of dual camera optics in which a beamsplitter is used within the lens system to simplify the optical design. This is an improvement on Pentland's use of completely separate optics, but still includes some unnecessary duplication in order to provide for multiple aperture settings as Pentland proposed.

Another improvement of Pentland's multiple camera method is described by Nourbakhsh et al. (U.S. Pat. No. 5,793,900). Nourbakhsh et al. describe a system using three cameras with different focus distance settings, rather than different apertures as in Pentland's presentation. This system allows for rapid calculation of ranges, but sacrifices range resolution in order to do so. The use of multiple sets of optics tends to make the camera system heavy and expensive. It is also difficult to synchronize the optics if overall focus, zoom, or iris need to be changed. The beamsplitters themselves must be large since they have to be sized to full aperture and field of view of the system. Moreover, the images formed in this way will not be truly identical due to manufacturing variations between the sets of optics.

An alternative method that uses only a single camera is described by Nakagawa et al. in U.S. Pat. No. 5,151,609. This approach is intended for use with a microscope. In this method, the object under consideration rests on a platform that is moved in steps toward or away from the camera. A large number of images can be obtained in this way, which increases the range finding power relative to Pentland's method. In a related variation, the camera and the object are kept fixed and the focus setting of the lens is changed step-wise. However, this method is not suitable when the object or camera is moving, since comparison between images taken at different times would be very difficult. Even in a static situation, such as a surveying application, the time to complete the measurement could be excessive. Even if the scene and the camera location and orientation are static, the acquisition of multiple images by changing the camera settings is time consuming and introduces problems of control, measurement, and recording of the camera parameters to associate with the images. Also, changing the focus setting of a lens may cause the image to shift laterally if the lens rotates during the focus change and optical axes and the rotation axis are not in perfect alignment.

Thus, it would be desirable to provide a simplified method by which ranges of objects can be determined rapidly and accurately under a wide variety of conditions. In particular, it would be desirable to provide a method by which range-mapping for substantially all objects in the field of view of a camera can be provided rapidly and accurately. It would be especially desirable if such range-mapping can be performed continuously and in real time. It is further desirable to perform this range-finding using relatively simple, portable equipment.

### SUMMARY OF THE INVENTION

In one aspect, this invention is a camera comprising

(a) a focusing means

(b) multiple image sensors which receive two-dimensional images, said image sensors each being located at different optical path lengths from the focusing means and,

(c) a beamsplitting system for splitting light received though the focusing means into three or more beams and projecting said beams onto multiple image sensors to form multiple, substantially identical images on said image sensors.

The focussing means is, for example, a lens or focussing mirror. The image sensors are, for example, photographic film, a CMOS device, a vidicon tube or a CCD, as described more fully below. The image sensors are adapted (together with optics and beamsplitters) so that each receives an image corresponding to at least about half, preferably most and most preferably substantially all of the field of view of the camera.

The camera of the invention can be used as described herein to calculate ranges of objects within its field of view. The camera simultaneously creates multiple, substantially identical images which are differently focussed and thus can be used for range determinations. Furthermore, the images can be obtained without any changes in camera position or camera settings.

In a second aspect, this invention is a method for determining the range of an object, comprising

(a) framing the object within the field of view of a camera having a focusing means

(b) splitting light received through and focussed by the focusing means and projecting substantially identical images onto multiple image sensors that are each located at different optical path lengths from the focusing means,

(c) for at least two of said multiple image sensors, identifying a section of said image that includes at least a portion of said object, and for each of said sections, calculating a focus metric indicative of the degree to which said section of said image is in focus on said image sensor, and

(d) calculating the range of the object from said focus metrics.

This aspect of the invention provides a method by which ranges of individual objects, or a range map of all objects within the field of view of the camera can be made quickly and, in preferred embodiments, continuously or nearly continuously. The method is passive and allows the multiple images that form the basis of the range estimation to be obtained simultaneously without moving the camera or adjusting camera settings.

In a third aspect, this invention is a beamsplitting system for splitting a focused light beam through n levels of splitting to form multiple, substantially identical images, comprising

(a) an arrangement of 2ⁿ−1 beamsplitters which are each capable of splitting a focused beam of incoming light into two beams, said beamsplitters being hierarchically arranged such that said focussed light beam is divided into 2ⁿ beams, n being an integer of 2 or more.

This beamsplitting system produces multiple, substantially identical images that are useful for range determinations, among other uses. The hierarchical design allows for short optical path lengths as well as small physical dimensions. This permits a camera to frame a wide field of view, and reduces overall weight and size.

In a fourth aspect, this invention is a method for determining the range of an object, comprising

(a) framing the object within the field of view of camera having a focusing means,

(b) splitting light received through and focussed by the focusing means and projecting substantially identical images onto multiple image sensors that are each located at a different optical path length from the focusing means,

(c) for at least two of said multiple image sensors, identifying a section of said image that includes at least a portion of said object, and for each of said sections, determining the difference in squares of the blur radii or blur diameter for a point on said object and,

(d) determining the range of the object based on the difference in the squares of the blur radii or blur diameter.

As with the second aspect, this aspect provides a method by which rapid and continuous or nearly continuous range information can be obtained, without moving or adjusting camera settings.

In a fifth aspect, this invention is a method for creating a range map of objects within a field of view of a camera, comprising

(a) framing an object space within the field of view of camera having a focusing means,

(b) splitting light received through and focussed by the focusing means and projecting substantially identical images onto multiple image sensors that are each located at a different optical path length from the focusing means,

(c) for at least two of said multiple image sensors, identifying sections of said images that correspond to substantially the same angular sector of the object space,

(d) for each of said sections, calculating a focus metric indicative of the degree to which said section of said image is in focus on said image sensor,

(e) calculating the range of an object within said angular sector of the object space from said focus metrics, and

(f) repeating steps (c)-(e) for all sections of said images.

This aspect permits the easy and rapid creation of range maps for objects within the field of view of the camera.

In a sixth aspect, this invention is a method for determining the range of an object, comprising

(a) forming at least two substantially identical images of at least a portion of said object on one or more image sensors, where said substantially identical images are focussed differently;

(b) for sections of said substantially identical images that correspond to substantially the same angular sector in object space and include an image of at least a portion of said object, analyzing the brightness content of each image at one or more spatial frequencies by performing a discrete cosine transformation to calculate a focus metric, and

(c) calculating the range of the object from the focus metrics.

This aspect of the invention allows range information to be made from substantially identical images of a scene that differ in their focus, using an algorithm of a type that is incorporated into common processing devices such as JPEG, MPEG2 and JPEG processors. In this aspect, the images are not necessarily taken simultaneously, provided that they differ in focus and the scene is static. Thus, this aspect of the invention is useful with cameras of various designs and allows range estimates to be formed using conveniently available cameras and processors.

### BRIEF DESCRIPTION OF THE DRAWINGS

FIG. 1 is an isometric view of an embodiment of the camera of the invention.

FIG. 2 is a cross-section view of an embodiment of the camera of the invention.

FIG. 3 is a cross-section view of a second embodiment of the camera of the invention.

FIG. 4 a cross-section view of a third embodiment of the camera of the invention.

FIG. 5 is a diagram of an embodiment of a lens system for use in the invention.

FIG. 6 is a diagram illustrating the relationship of blur diameters and corresponding Gaussian brightness distributions to focus.

FIG. 7 is a diagram illustrating the blurring of a spot object with decreasing focus.

FIG. 8 is a graph demonstrating, for one embodiment of the invention, the variation of the blur radius of a point object as seen on several image sensors as the distance of the point object changes.

FIG. 9 is a graph illustrating the relationship of Modulation Transfer Function to spatial frequency and focus.

FIG. 10 is a block diagram showing the calculation of range estimates in one embodiment of the invention.

FIG. 11 is a schematic diagram of an embodiment of the invention.

FIG. 12 is a schematic diagram showing the operation of a vehicle navigation system using the invention.

### DETAILED DESCRIPTION OF THE INVENTION

In this invention, the range of one or more objects is determined by bringing the object within the field of view of a camera. The incoming light enters the camera through a focussing means as described below, and is then passed through a beamsplitter system that divides the incoming light and projects it onto multiple image sensors to form substantially identical images. Each of the image sensors is located at a different optical path length from the focussing means. The “optical path length” is the distance light must travel from the focussing means to a particular image sensor, divided by the refractive index of the medium it traverses along the path. Sections of two or more of the images that correspond to substantially the same angular sector in object space are identified. For each of these corresponding sections, a focus metric is determined that is indicative of the degree to which that section of the image is in focus on that particular image sensor. Focus metrics from at least two different image sensors are then used to calculate an estimate the range of an object within that angular sector of the object space. By repeating the process of identifying corresponding sections of the images, calculating focus metrics and calculating ranges, a range map can be built up that identifies the range of each object within the field of view of the camera.

As used in this application “substantially identical images” are images that are formed by the same focussing means and are the same in terms of field of view, perspective and optical qualities such as distortion and focal length. Although the images are formed simultaneously when made using the beamsplitting method described herein, images that are not formed simultaneously may also be considered to be “substantially identical”, if the scene is static and the images meet the foregoing requirements. The images may differ slightly in overall brightness, color balance and polarization. Images that are different only in that they are reversed (i.e., mirror images) can be considered “substantially identical” within the context of this invention. Similarly, images received by the various image sensors that are focussed differently on account of the different optical path lengths to the respective image sensors, but are otherwise the same (except for reversals and/or small brightness changes, or differences in color balance and polarization as mentioned above) are considered to be “substantially identical” within the context of this invention.

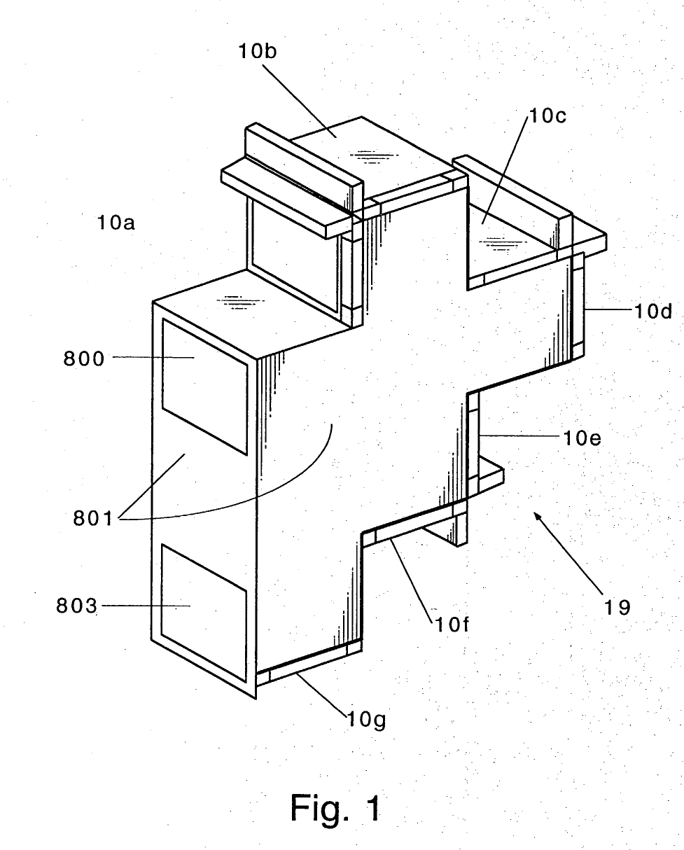

In FIG. 1, Camera 19 includes an opening 800 through which focussed light enters the camera. A focussing means (not shown) will be located over opening 800 to focus the incoming light. The camera includes a beamsplitting system that projects the focussed light onto image sensors 10a-10g. The camera also includes a plurality of openings such as opening 803 through which light passes from the beamsplitter system to the image sensors. As is typical with most cameras, the internal light paths and image sensors are shielded from ambient light. Covering 801 in FIG. 1 performs this function and can also serve to provide physical protection, hold the various elements together and house other components.

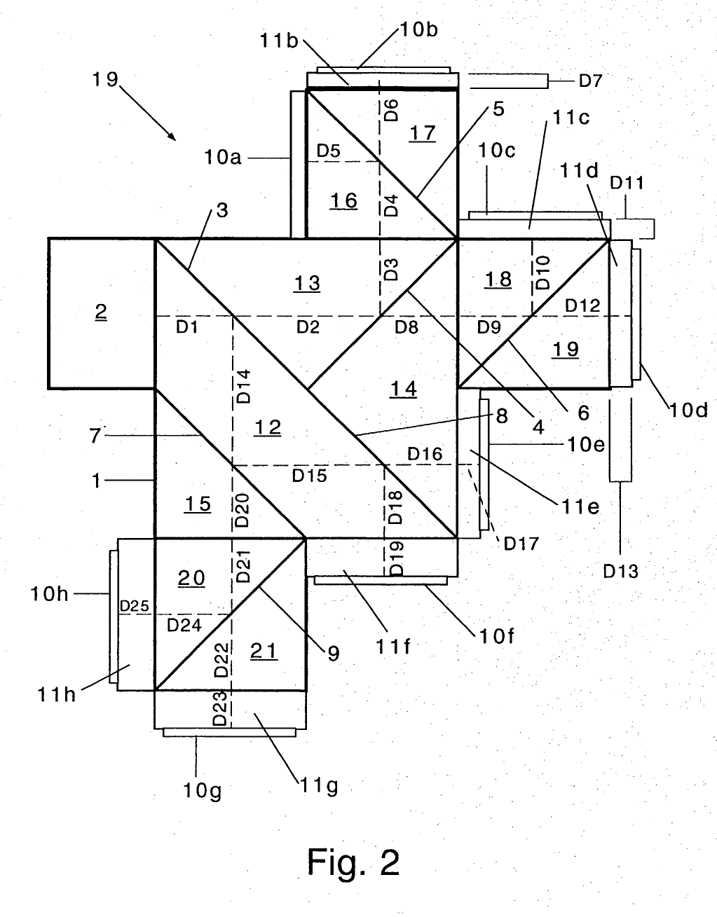

FIG. 2 illustrates the placement of the image sensors in more detail, for one embodiment of the invention. Camera 19 includes a beamsplitting system 1, a focussing means represented by box 2 and, in this embodiment, eight image sensors 10a-h. Light enters beamsplitting system 1 through focussing means 2 and is split as it travels through beamsplitting system 1 so as to project substantially identical images onto image sensors 10a-10h. In the embodiment shown in FIG. 2, multiple image generation is accomplished through a number of partially reflective surfaces 3-9 that are oriented at an angle to the respective incident light rays, as discussed more fully below. Each of the images is then projected onto one of image sensors 10a-10h. Each of image sensors 10a-10h is spaced at a different optical path length (Dₐ−Dₕ, respectively) from focussing means 2. In FIG. 2, the paths of the various central light rays through the camera are indicated by dotted lines, whose lengths are indicated as D₁ through D₂₅. Intersecting dotted lines indicate places at which beam splitting occurs. Thus, in the embodiment shown, image sensor 10a is located at an optical path length Da, wherein

Dₐ=D₁/n₁₂+D₂/n₁₃+D₃/n₁₃+D₄/n₁₆+D₅/n₁₆

Similarly,

D_{b}=D₁/n₁₂+D₂/n₁₃+D₃/n₁₃+D₄/n₁₆+D₆/n₁₇+D₇/n_{11b},

D_{c}=D₁/n₁₂+D₂/n₁₃+D₈/n₁₄+D₁/n₁₈+D₁₀/n₁₈+D₁₁/n_{11c}

D_{d}=D₁/n₁₂+D₂/n₁₃+D₈/n₁₄+D₉/n₁₈+D₁₂/n₁₉+D₁₃/n_{11d},

Dₑ=D₁/n₁₂+D₁₄/n₁₂+D₁₅/n₁₂+D₁₆/n₁₄+D₁₇/n₁₁ₑ,

D_{f}=D₁/n₁₂+D₁₄/n₁₂+D₁₅/n₁₂+D₁₈/n₁₂+D₁₉/n_{11f},

D_{g}=D₁/n₁₂+D₁₄/n₁₂+D₂₀/n₁₅+D₂₁/n₂₀+D₂₂/n₂₁+D₂₃/n_{11g}, and

Dₕ=D₁/n₁₂+D₁₄/n₁₂+D₂₀/n₁₅+D₂₁/n₂₀+D₂₄/n₂₀+D₂₅/n₁₁ₕ

where n_{11b-11h} and n₁₂₋₂₁ are the indices of refraction of spacers 11b-11h and prisms 12-21, respectively. As shown, Dₐ<D_{b}<D_{c}<D_{d}<Dₑ<D_{f}<D_{g}<Dₕ.

Typically, the camera of the invention will be designed to provide range information for objects that are within a given set of distances (“operating limits”). The operating limits may vary depending on particular applications. The longest of the optical path lengths (Dₕ in FIG. 2) will be selected in conjunction with the focussing means so that objects located near the lower operating limit (i.e., closest to the camera) will be in focus or nearly in focus at the image sensor located farthest from the focussing means (image sensor 10h in FIG. 2). Similarly, the shortest optical path length optical path length (Dₐ in FIG. 2) will be selected so that objects located near the upper operating limit (i.e., farthest from the camera) will be in focus or nearly in focus at the image sensor located closest from the focussing means (image sensor 10a in FIG. 2).

Although the embodiment shown in FIG. 2 splits the incoming light into eight images, it is sufficient for estimating ranges to create as few as two images and as many as 64 or more. In theory, increasing the number of images (and corresponding image sensors) permits greater accuracy in range calculation. However, intensity is lost each time a beam is split, so the number of useful images that can be created is limited. In practice, good results can be obtained by creating as few as three images, preferably at least four images, more preferably about 8 images, to about 32 images, more preferably about 16 images. Creating about 8 images is most preferred.

FIG. 2 illustrates a preferred binary cascading method of generating multiple images. In the method, light entering the beamsplitter system is divided into two substantially identical images, each of which is divided again into two to form a total of four substantially identical images. To make more images, each of the four substantially identical images is again split divided into two, and so forth until the desired number of images has been created. In this embodiment, the number of times a beam is split before reaching an image sensor is n, and the number of created images in 2ⁿ. The number of individual surfaces at which splitting occurs is 2ⁿ-1. Thus, in FIG. 2, light enters beamsplitter system 1 from focussing means 2 and contacts partially reflective surface 3. As shown, partially reflective surface 3 is oriented at 45° to the path of the incoming light, and is partially reflective so that a portion of the incoming light passes through and most of the remainder of the incoming light is reflected at an angle. In this manner, two beams are created that are oriented at an angle to each other. These two beams contact partially reflective surfaces 4 and 7, respectively, where they are each split a second time, forming four beams. These four beams then contact partially reflective surfaces 5, 6, 8 and 9, where they are each split again to form the eight beams that are projected onto image sensors 10a-10h. The splitting is done such that the images formed on the image sensors are substantially identical as described before. If desired, additional partially reflective surfaces can be used to further subdivide each of these eight beams, and so forth one or more additional times until the desired number of images is created. It is most preferred that each of partially reflective surfaces 3-9 reflect and transmit approximately equal amounts of the incoming light. To minimize overall physical distances, the angle of reflection is in each case preferably about 45°.

The preferred binary cascading method of producing multiple substantially identical images allows a large number of images to be produced using relatively short overall physical distances. This permits less bulky, lighter weight equipment to be used, which-increases the ease of operation. Having shorter path lengths also permits the field of view of the camera to be maximized without using supplementary optics such as a retrofocus lens.

Partially reflective surfaces 3-9 are at fixed physical-distances and angles with respect to focussing means 2. Two preferred means for providing the partially reflective surfaces are prisms having partially reflective coatings on appropriate faces, and pellicle mirrors. In the embodiment shown in FIG. 2, partially reflective surface 3 is formed by a coating on one face of prism 12 or 13. Similarly, partially reflective surface 4 is formed by a coating on a face of prism 13 or 14, reflective surfaces 8 is formed by a coating on a face of prism 12 or 14, and

partially reflective surfaces 5, 6, 7 and 9 are formed by a coating on the bases of prisms 16 or 17, 18 or 19, 12 or 15 and 20 or 21, respectively. As shown, prisms 13-21 are right triangular in cross-section and prism 12 is trapezoidal in cross-section. However, two or more of the prisms can be made as a single piece, particularly when no partially reflective is present at the interface. For example, prisms 12 and 14 can form a single piece, as can prisms 15 and 20, 13 and 16, and 14 and 18.

To reduce lateral chromatic aberration and standardize the physical path lengths, it is preferred that the refractive index of each of prisms 12-21 be the same. Any optical glass such as is useful for making lenses or other optical equipment is a useful material of construction for prisms 12-21. The most preferred glasses are those with low dispersion. An example of such a low dispersion glass is crown glass BK7. For applications over a wide range of temperature, a glass with a low thermal expansion coefficient such as fused quartz is preferred. Fused quartz also has low dispersion, and does not turn brown when exposed to ionizing radiation, which may be desirable in some applications.

If a particularly wide field of view is required, prisms having relatively high indices of refraction can be used. This has the effect of providing shorter optical path lengths, which permits shorter focal length while retaining the physical path length and the transverse dimensions of the image sensors. This combination increases the field of view. This tends to increase the overcorrected spherical aberration and may tend to increase the overcorrected chromatic aberration introduced by the materials of manufacture of the prisms. However, these aberrations can be corrected by the design of the focusing means, as discussed below.

Suitable partially reflective coatings include metallic, dielectric and hybrid metallic/dielectric coatings. The preferred type of coating is a hybrid metallic/dielectric coating which is designed to be relatively insensitive to polarization and angle of incidence over the operating range of wavelength. Metallic-type coatings are less suitable because the reflection and transmission coefficients for the two polarization directions are unequal. This causes the individual beams to have significantly different intensities following two or more splittings. In addition, metallic-type coatings dissipate a significant proportion of the light energy as heat. Dielectric type coatings are less preferred because they are sensitive to the angle of incidence and polarization. When a dielectric coating is used, a polarization rotating device such as a half-wave plate or a circularly polarizing ¼-wave plate can be placed between each pair of partially reflecting surfaces in order to compensate for the polarization effects of the coatings. If desired, a polarization rotating or circularizing device can also be used in the case of metallic type coatings.

The beamsplitting system will also include a means for holding the individual partially reflective surfaces into position with respect to each other. Suitable such means may be any kind of mechanical means, such as a case, frame or other exterior body that is adapted to hold the surfaces into fixed positions with respect to each other. When prisms are used, the individual prisms may be cemented together using any type of adhesive that is transparent to the wavelengths of light being monitored. A preferred type of adhesive is an ultraviolet-cure epoxy with an index of refraction matched to that of the prisms.

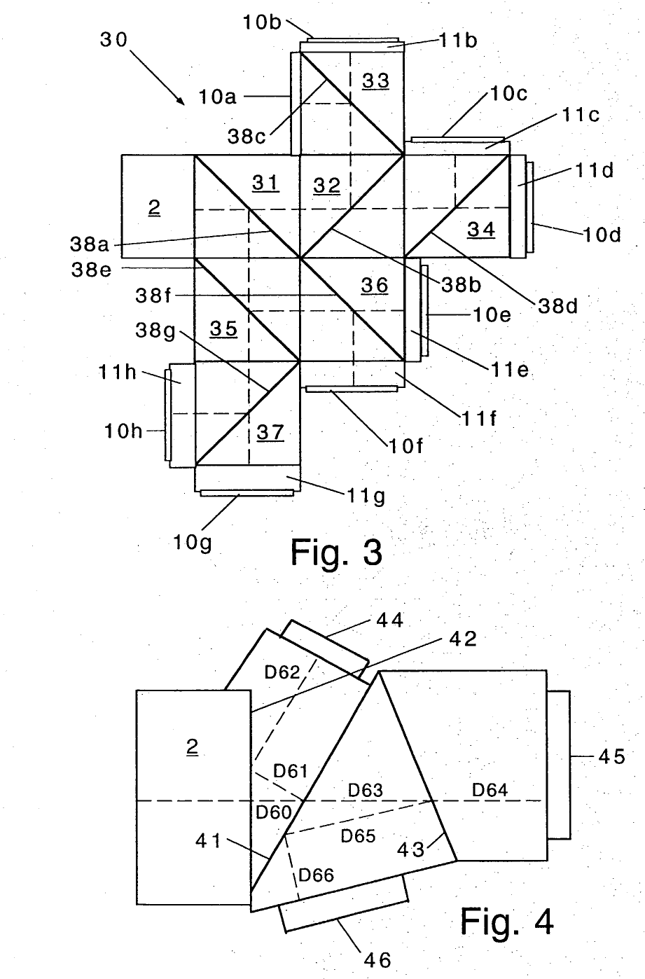

FIG. 3 illustrates how prism cubes such as are commercially available can be assembled to create a beamsplitter equivalent to that shown in FIG. 2. Beamsplitter system 30 is made up of prism cubes 3i-37, each of which contains a diagonally oriented partially reflecting surface (38a-g, respectively). Focussing means 2, spacers 11a-11h and image sensors 10a-10h are as described in FIG. 2. As before, the individual-prism cubes are held in position by mechanical means, cementing, or other suitable method.

FIG. 4 illustrates another alternative beamsplitter design, which is adapted from beamsplitting systems that are used for color separations, as described by Ray in Applied Photographic Optics, Second Ed., 1994, p. 560 (FIG. 68.2). In FIG. 4, incoming light enters the beamsplitter system through focussing means 2 and impinges upon partially reflective surface 41. A portion of the light (the path of the light being indicated by the dotted lines) passes through partially reflective surface 41 and impinges upon partially reflective surface 43. Again, a portion of this light passes through partially reflective surface 43 and strikes image sensor 45. The portion of the incoming light that is reflected by partially reflective surface 41 strikes reflective surface 42 and is reflected onto image sensor 44. The portion of the light that is reflected by partially reflective surface 43 strikes a reflective portion of surface 41 and is reflected onto image sensor 46. Image sensors 44, 45 and 46 are at different optical path lengths from focussing means 2, i.e. D₆₀/n₆₀+D₆₁/n₆₁+D₆₂/n₆₂≠D₆₀/n₆₀+D₆₃/n₆₃+D₆₄/n₆₄≠D₆₀/n₆₀+D₆₃/n₆₃+D₆₅/n₆₅+D₆₆/n₆₆, where n₆₀-n₆₆ represent the refractive indices along distances D₆₀−D₆₆, respectively. It is preferred that the proportion of light that is reflected at surfaces 41 and 43 be such that images of approximately equal intensity reach each of image sensors 44, 45 and 46.

Although specific beamsplitter designs are provided in FIGS. 2, 3 and 4, the precise design of the beamsplitter system is not critical to the invention, provided that the beamsplitter system delivers substantially identical images to multiple image sensors located at different path lengths from the focussing means.

The embodiment in FIG. 2 also incorporates a preferred means by which the image sensors are held at varying distances from the focussing means. In FIG. 2, the various image sensors 10b-10h are held apart from beamsplitter system 1 by spacers 11b-11h, respectively. Spacers 11b-11h are transparent to light, thereby permitting the various beams to pass through them to the corresponding image sensor. Thus, the spacer can be a simple air gap or another material that preferably has the same refractive index as the prisms. The use of spacers in this manner has at least two benefits. First, the thickness of the spacers can be changed in order to adjust operating limits of the camera, if desired. Second, the use of spacers permits the beamsplitter system to be designed so that the optical path length from the focussing means (i.e., the point of entrance of light into the beamsplitting system) to each spacer is the same, with the difference in total optical path length (from focussing means to image sensor) being due entirely to the thickness of the spacer. This allows for simplification in the design of the beamsplitter system.

Thus, in the embodiment shown in FIG. 2, D₁/n₁₂+D₂/n₁₃+D₃/n₁₃+D₄/n₁₆+D₅/n₁₆=D₁/n₁₂+D₂/n₁₃+D₃/n₁₃+D₄/n₁₆+D₆/n₁₇=D₁/n₁₂+D₂/n₁₃+D₈/n₁₄+D₉/n₁₈+D₁₀/n₁₈=D₁/n₁₂+D₂/n₁₃+D₈/n₁₄+D₉/n₁₈+D₁₂/n₁₉=D₁/n₁₂+D₁₄/n₁₂+D₁₅/n₁₂+D₁₆/n₁₄=D₁/n₁₂+D₁₄/n₁₂+D₁₅/n₁₂+D₁₈/n₁₂=D₁/n₁₂+D₁₄/n₁₂+D₂₀/n₁₅+D₂₁/n₂₀+D₂₂/n₂₁=D₁/n₁₂+D₁₄/n₁₂+D₂₀/n₁₅+D₂₁/n₂₀+D₂₄/n₂₀, and the thicknesses of spacers 11b-11h (D₇, D₁₁, D₁₃, D₁₇, D₁₉, D₂₃ and D₂₅, respectively) are all unique values, with the refractive indices of the spacers all being equal values.

Of course, a spacer may be provided for image sensor 10a if desired.

An alternative arrangement is to use materials having different refractive indices as spacers 11b-11h. This allows the thicknesses of spacers 11b-11h to be the same or more nearly the same, while still providing different optical path lengths.

In another preferred embodiment, the various optical path lengths (Dₐ−Dₕ in FIG. 2) differ from each other in constant increments. Thus, if the lengths of the shortest two optical path lengths differ by a distance X, then it is preferred that the differences in length between the shortest optical path length and any other optical path length be mX, where m is an integer from 2 to the number of image sensors minus one. In the embodiment shown in FIG. 2, this is accomplished by making the thickness of spacer 11b equal to X, and those of spacers 11c-11h being from 2X to 7X, respectively. As mentioned before, the thickness of spacer 11h should be such that objects which are at the closest end of the operating range are in focus or nearly in focus on image sensor 10h. Similarly, Dₐ(=D₁/n₁₂+D₂/n₁₃+D₃/n₁₃+D₄/n₁₆+D₅/n₁₆) should be such that the objects which are at the farthest end of the operating range are in focus or nearly in focus on image sensor 10a.

Focussing means 2 is any device that can focus light from a remote object being viewed onto at least one of the image sensors. Thus, focussing means 2 can be a single lens, a compound lens system, a mirror lens (such as a Schmidt-Cassegrain mirror lens), or any other suitable method of focussing the incoming light as desired. If desired, a zoom lens, telephoto or wide angle lens can be used. The lens will most preferably be adapted to correct any aberration introduced by the beamsplitter. In particular, a beamsplitter as described in FIG. 2 will function optically much like a thick glass spacer, and when placed in a converging beam, will introduce overcorrected spherical and chromatic aberrations. The focussing means should be designed to compensate for these.

Similarly, it is preferred to use a compound lens that corrects for aberration caused by the individual lenses. Techniques for designing focussing means, including compound lenses, are well known and described, for example, in Smith, “Modern Lens Design”, McGraw-Hill, New York (1992). In addition, lens design software programs can be used to design the focussing system, such as OSLO Light (Optics Software for Layout and Optimization), Version 5, Revision 5.4, available from Sinclair Optics, Inc. The focussing means may include an adjustable aperture. However more accurate range measurements can be made when the depth of field is small. Accordingly, it is preferable that a wide aperture be used. One corresponding to an f-number of about 5.6 or less, preferably 4 or less, more preferably 2 or less is especially suitable.

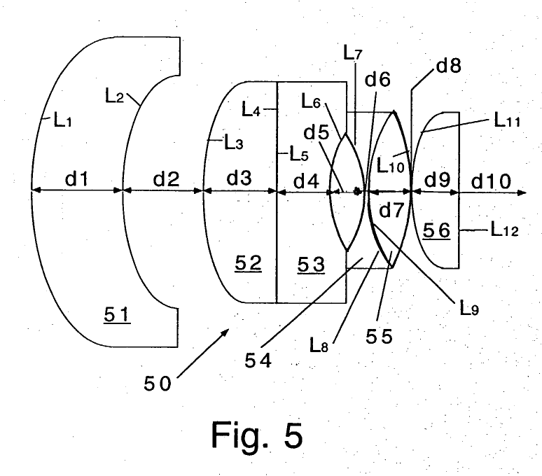

A particularly suitable focussing means is a 6-element Biotar (also known as double Gauss-type) lens. One embodiment of such a lens is illustrated in FIG. 5, and is designed to correct the aberrations created with a beamsplitter system as shown in FIG. 2, which are equivalent to those created by a 75 mm plate of BK7 glass. Biotar lens 50 includes lens 51 having surfaces L₁ and L₂ and thickness d₁; lens 52 having surfaces L₃ and L₄ and thickness d₃; lens 53 having surfaces L₅ and L₆ and thickness d₄; lens 54 having surfaces L₇ and L₈ and thickness d₆; lens 55 having surfaces L₉ and L₁₀ and thickness d₇ and lens 56 having surfaces L₁₁ and L₁₂ and thickness d₉. Lenses 51 and 52 are separated by distance d₂, lenses 53 and 54 are separated by distance d₅, and lenses 55 and 56 are separated by distance d₈. Lens pairs 52-53 and 54-55 are cemented doublets. Parameters of this modified lens are summarized in the following table:

| Surface | Radius of | Distance | Length |
|---|---|---|---|
| No. | Curvature | No. | (mm) |
| L₁ | 42.664 | d₁ | 15 |
| L₂ | 29.0271 | d₂ | 11.5744 |
| L₃ | 46.5534 | d₃ | 15 |
| L₄, L₅ | ∞ | d₄ | 12.1306 |
| L₆ | 31.9761 | d₅ | 6 |
| L₇ | −33.8994 | d₆ | 1 |
| L₈, L₉ | 43.0045 | d₇ | 8.9089 |
| S₁₀ | −36.8738 | d₈ | 0.5 |
| S₁₁ | 71.1621 | d₉ | 6.5579 |
| S₁₂ | ∞ | d₁₀ (to | 1 |
| | | camera) | |

| | Refractive | Abbe-V | |
|---|---|---|---|
| Lens | index | number | Glass type |
| 51 | 1.952497 | 20.36 | SF59 |
| 52 | 1.78472 | 25.76 | SF11 |
| 53 | 1.518952 | 57.4 | K4 |
| 54 | 1.78472 | 25.76 | SF11 |
| 55 | 1.880669 | 41.01 | LASFN31 |
| 56 | 1.880669 | 41.01 | LASFN31 |

Image sensors 10a-10h can be any devices that record the incoming image in a manner that permits calculation of a focus metric that can in turn be used to calculate an estimate of range. Thus, photographic film can be used, although film is less preferred because range calculations must await film development and determination of the focus metric from the developed film or print. For this reason, it is more preferred to use electronic image sensors such as a vidicon tube, complementary metal oxide semiconductor (CMOS) devises or, especially, charge-coupled devices (CCDs), as these can provide continuous information from which a focus metric and ranges can be calculated. CCDs are particularly preferred. Suitable CCDs are commercially available and include those types that are used in high-end digital photography or high definition television applications. The CCDs may be color or black-and-white, although color CCDs are preferred as they can provide more accurate range information as well as more information about the scene being photographed. The CCDs may also be sensitive to wavelengths of light that lie outside the visible spectrum. For example, CCDs adapted to work with infrared radiation may be desirable for night vision applications. Long wavelength infrared applications are possible using microbolometer sensors and LWIR optics (such as, for example, germanium prisms in the beamsplitter assembly).

Particularly suitable CCDs contain from about 500,000 to about 10 million pixels or more, each having a largest dimension of from about 3 to about 20, preferably about 8 to about 13 μm. A pixel spacing of from about 3-30 μm is preferred, with those having a pixel spacing of 10-20 μm being more preferred. Commercially available CCDs that are useful in this invention include Sony's ICX252AQ CCD, which has an array of 2088×1550 pixels, a diagonal dimension of 8.93 mm and a pixel spacing of 3.45 μm; Kodak's KAF-2001CE CCD, which has an array of 1732×1172 pixels, dimensions of 22.5×15.2 mm and a pixel spacing of 13 μm; and Thomson-CSF TH7896M CCD, which has an array of 1024×1024 pixels and a pixel size of 19 μm.

In addition to the components described above, the camera will also include a housing to exclude unwanted light and hold the components in the desired spatial arrangement. The optics of the camera may include various optional features, such as a zoom lens; an adjustable aperture; an adjustable focus; filters of various types, connections to power supply, light meters, various displays, and the like.

Ranges of objects are estimated in accordance with the invention by developing a focus metrics from the images projected onto two or more of the image sensors that represent the same angular sector in object space. An estimate of the range of one or more objects within the field of view of the camera is then calculated from the focus metrics. Focus metrics of various types can be used, with several suitable types being described in Krotov, “Focusing”, Int. J. Computer Vision 1:223-237 (1987), incorporated herein by reference, as well as in U.S. Pat. No. 5,151,609. In general, a focus metric is developed by examining patches of the various images for their high spatial frequency content. Spatial frequencies up to about 25 lines/mm are particularly useful for developing the focus metric. When an image is out of focus, the high spatial frequency content is reduced. This is reflected in smaller brightness differences between nearby pixels. The extent to which these brightness differences are reduced due to an image being out-of-focus on a particular image sensor provides an indication of the degree to which the image is out of focus, and allows calculation of range estimates.

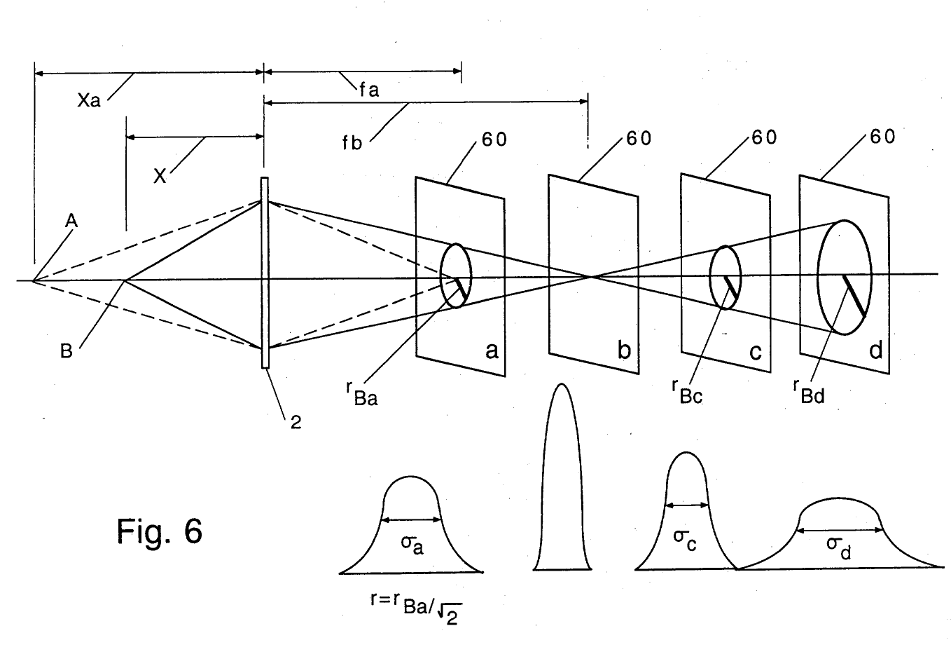

The preferred method develops a focus metric and range calculation based on blur diameters or blur radii, which can be understood with reference to FIG. 6. Distances in FIG. 6 are not to scale. In FIG. 6, B represents a point on a remote object at is at distance x from the focussing means. Light from that object passes through focussing means 2, and is projected onto image sensor 60, which is shown at alternative positions a, b c and d. When image sensor 60 is at position b, point B is in focus on image sensor 60, and appears essentially as a point. As image sensor 60 is moved so that point B is no longer in focus, point B is imaged as a circle, as shown on image sensors at positions a, c and d. The radius of this circle is the blur radius, and is indicated for positions a, c and d as r_{Ba}, r_{Bc} and r_{Bd}. Twice this value is the blur diameter. As shown in FIG. 6, blur radii (and blur diameters) increase as the image sensor becomes farther removed from having point B in focus. Because the various image sensors in this invention are at different optical path lengths from the focussing means, point objects such as point object B in FIG. 6 will appear on the various image sensors as blurred circles of varying radii.

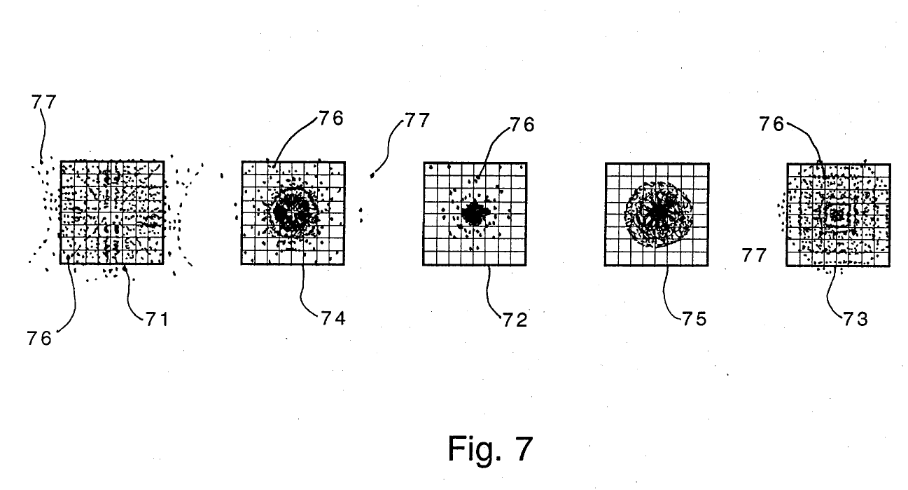

This effect is illustrated in FIG. 7, which is somewhat idealized for purposes of illustration. In FIG. 7, an 8×8 block of pixels from each of 3 CCDs are represented as 71, 72 and 73, respectively. These three CCDs are adjacent to each other in terms of being at consecutive optical path lengths from the focussing means, with the CCD containing pixel block 72 being intermediate to the others. Each of these 8×8 blocks of pixels receives light from the same angular sector in object space. For purposes of this illustration, the object is a point source of light that is located at the best focus distance for the CCD containing pixel block 72, in a direction corresponding to the center of the pixel block. Pixel block 72 has an image nearly in sharp focus, whereas the same point image is one step out of focus in pixel blocks 71 and 73. Pixel blocks 74 and 75 represent pixel blocks on image sensors that are one-half step out of focus. The density of points 76 on a particular pixel indicates the intensity of light that pixel receives. When an image is in sharp focus in the center of the pixel block, as in pixel block 72, the light is imaged as high intensities on relatively few pixels. As the focus becomes less sharp, more pixels receive light, but the intensity on any single pixel decreases. If the focus is too far out of focus, as in pixel block 71, some of the light is lost to adjoining pixel blocks (points 77).

For any particular image sensor i, objects at certain distances xᵢ will be in focus. In FIG. 6, this is shown with respect to the image sensor a, which has point object A at distance xₐ in focus. The diameter of a blur circle (D_{B}) on image sensor i for an object at distance x is related to this distance xᵢ, the actual distance of the object (x), the focal length of the focussing means (f) and the diameter of the entrance pupil (p) as follows:

D_{B}=fp[|xᵢ−x|/xxᵢ] (1)

Although equation (1) suggests that the blur diameter will go to zero for an object in sharp focus (xᵢ−x=0), diffraction and optical aberrations will in practice cause a point to be imaged as a small fuzzy circle even when in sharp focus. Thus, a point object will be imaged as a circle having some minimum blur circle diameter due to imperfections in the equipment and physical limitations related to the wavelength of the light, even when in sharp focus. This limiting spot size can be added to equation (1) as a sum of squares to yield the following relationship:

D_{B}²={fp[|xᵢ−x|/xxᵢ]}²+(Dₘᵢₙ)² (2)

where Dₘᵢₙ represents the minimum blur circle diameter.

An image projected onto any two-image sensors Sⱼ and Sₖ, which are focussed at distances xⱼ and xₖ, respectively, will appear as blurred circles having blur diameters Dⱼ and Dₖ, respectively. The distance x of the point object can be calculated from the blur diameters, xⱼ and xₖ using the equation

$$x = \frac{2 ( \frac{1}{{x}_{j}} - \frac{1}{{x}_{k}} )}{\frac{1}{{x}_{j}^{2}} - \frac{1}{{x}_{k}^{2}} - \frac{{D}_{j}^{2} - {D}_{k}^{2}}{{( fp )}^{2}}} \qquad ( 3 )$$

In equation (3), xⱼ and xₖ are known from the optical path lengths for image sensors j and k, and f and p are constants for the particular equipment used. Thus, by measuring the diameter of the blur circles for a particular point object imaged on image sensors j and k, the range x of the object can be determined. In this invention, the range of an object is determined by identifying on at least two image sensors an area of an image corresponding to a point on said object, calculating the difference in the squares of the blur diameter of the image on each of the image sensors, and calculating the range x from the blur diameters, such as according to equation (3).

It is clear from equation (3) that a measurement of (Dⱼ²−Dₖ²) is sufficient to calculate the range x of the object. Thus, it is not necessary to measure Dⱼ and Dₖ directly if the difference of their squares (Dⱼ²−Dₖ²) can be measured instead.

The accuracy of the range measurement improves significantly when the point object is in sharp focus or nearly in sharp focus on the image sensors upon which the measurement is based. Accordingly, this invention preferably includes the step of identifying the two image sensors upon which the object is most nearly in focus, and calculating the range of the object from the blur radii on those two image sensors.

Electronic image sensors such as CCDs image points as brightness functions. For a point image, these brightness functions can be modeled as Gaussian functions of the radius of the blur circle. A blur circle can be modeled as a Gaussian peak having a width (a) equal to the radius of the blur circle divided by the square root of 2 (or diameter divided by twice the square root of 2). This is illustrated in FIG. 6, where blur circles on the image sensors as points a, c and d are represented as Gaussian peaks. The width of each peak (σₐ, σ_{c} and σ_{d}, corresponding to the blur circles at positions a, c and d) are taken as equal to r_{Ba}/0.707, r_{Bc}/0.707 and r_{Bd}/0.707, respectively (or D_{Ba}/1.414, D_{Bc}/1.414 and D_{Bd}/1.414). Substituting this relationship into equation (3) yields equation (4):

$$x = \frac{2 ( \frac{1}{{x}_{j}} - \frac{1}{{x}_{k}} )}{\frac{1}{{x}_{j}^{2}} - \frac{1}{{x}_{k}^{2}} - \frac{{σ}_{j}^{2} - {σ}_{k}^{2}}{{( \frac{.707}{2} fp )}^{2}}} \qquad ( 4 )$$

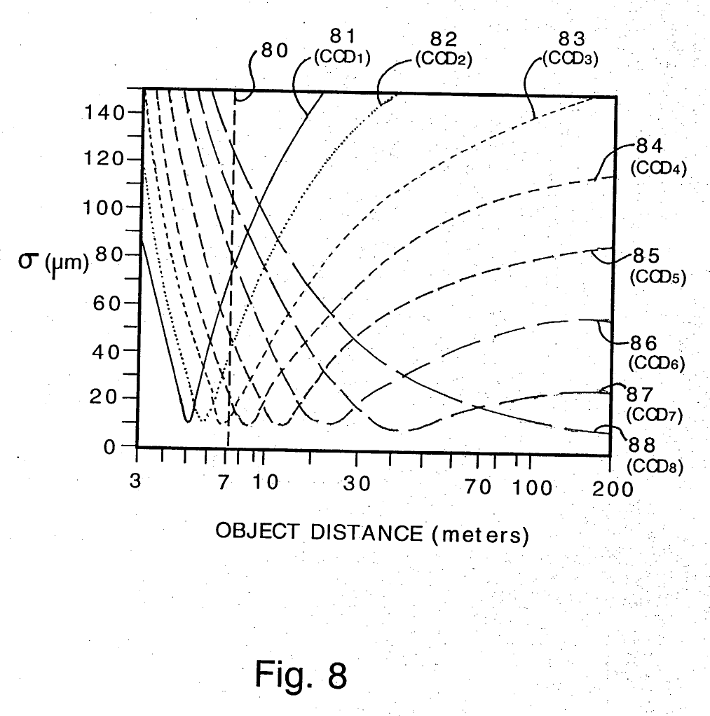

FIG. 8 demonstrates how, by using a number of image sensors located at different optical path lengths, point objects at different ranges appear as blur circles of varying diameters on different image sensors. Curves 81-88 represent the values of a of reach of eight image sensors as the distance of the imaged object increases. The data in FIG. 8 is calculated for a system of lens and image sensors having focus distances xᵢ in meters of 4.5, 5, 6, 7.5, 10, 15, 30 and ∞, respectively for the eight image sensors. An object at any distance x within the range of about 4 meters to infinity will be best focussed on the one of the image sensors (or in some cases, two of them), on which the value of σ is least. Line 80 indicates the σ value on each image sensor for an object at a range of 7 meters. To illustrate, in FIG. 8, a point object at a distance x of 7 meters is best focussed on image sensor 4, where σ is about 14 μm. The same point object is next best focused on image sensor 3, where σ is about 24 μm. For the system illustrated by FIG. 8, any point object located at distance x of about 4.5 meters to infinity will appear on at least one image sensor with a a value of between about 7.9 and 15 μm. Except for objects located at a distance of less than 4.5 meters, the image sensor next best in focus will image the object with a a value of from about 16 to about 32 μm.

Using equation (4), it is possible to determine the range x of an object by measuring σⱼ and σₖ, or by measuring σⱼ²−σₖ². Using CCDs as the image sensors, the value of σj²−σₖ² can be estimated by identifying blocks of pixels on two CCDs that each correspond to a particular angular sector in space containing a given point object, and comparing the brightness information from the blocks of pixels on the two CCDs. A signal can then be produced that is representative of or can be used to calculate σⱼ and σₖ or σⱼ²−σₖ². This can be done using various types of transform algorithms including various forms of Fourier analysis, wavelets, finite difference approximations to derivatives, and the like, as described by Krotov and U.S. Pat. No. 5,151,609, both mentioned above. However, a preferred method of comparing the brightness information is through the use of a Discrete Cosine Transformation (DCT) function, such as is commonly used in JPEG, MPEG and Digital Video compression methods.

In this DCT method, the brightness information from a set of pixels (typically an 8×8 block of pixels) is converted into a matrix of typically 64 cosine coefficients (designated as n, m, with n and m usually ranging from 0 to 7). Each of the cosine coefficients corresponds to the light content in that block of pixels at a particular spatial frequency. The relationship is given by

$$S ( m , n ) = {\sum }_{m = 0}^{N - 1} {\sum }_{n = 0}^{N - 1} c ( i , j ) cos \frac{π ( 2 m + 1 ) i}{2 N} cos \frac{π ( 2 n + 1 ) j}{2 N}$$

wherein c(i,j) represents the brightness of pixel i,j. Increasing values of n and m indicate values for increasing spatial frequencies according to the relationship

$${v}_{n , m} = \sqrt{{( \frac{n}{2 L} )}^{2} + {( \frac{m}{2 L} )}^{2}} \qquad ( 6 )$$

where v_{n,m} represents the spatial frequency corresponding to coefficient n,m and L is the length of the square block of pixels.

The first of these coefficients (0,0) is the so-called DC term. Except in the unusual case where σ>>L (i.e., the image is far out of focus), the DC term is not used for calculating σⱼ²−σₖ², except perhaps as a normalizing value. However, each of the remaining coefficients can be used to provide an estimate of σⱼ²−σₖ², as a given coefficient S_{n,m} generated by CCDⱼ and the corresponding coefficient S_{n,m} generated by CCDₖ are related to σⱼ²−σₖ² as follows:

σⱼ²−σₖ²=−L²/π²·ln[S_{n,m}(CCDⱼ)/S_{n,m}(CCDₖ)] (7)

Thus, the ratio of the coefficients between the two CCDs provides a direct estimate of σⱼ²−σₖ². Thus, in principle, each of the last 63 DCT coefficients (the so-called “AC” coefficients) can provide an estimate of σⱼ²−σₖ².

In practice, however, relatively few of the DCT coefficients provide meaningful estimates. As a result, it is preferred to use only a portion of the DCT coefficients to determine σⱼ²−σₖ². Useful DCT coefficients are readily identified by a Modulation Transfer Function (MTF), defined as MTF. =exp(−2π²v²σ²), wherein v is the spatial frequency expressed by the particular DCT coefficient and σ is as before. The MTF expresses the ratio of a particular DCT coefficient as measured with the value of the coefficient in the case of an ideal image; i.e. as would be expected if perfectly in focus and with “perfect” optics. When the MTF is about 0.2 or greater, the DCT coefficient is generally useful for calculating estimates of ranges.

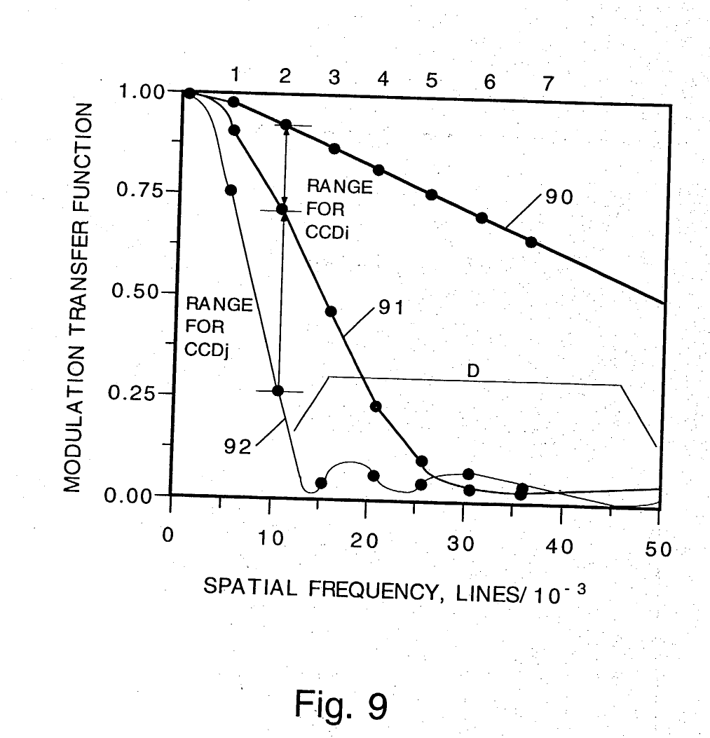

When the MTF is below about 0.2, interference effects tend to come into play, making the DCT coefficient a less reliable metric for calculating estimated ranges. This effect is illustrated in FIG. 9, in which MTF values are plotted against spatial frequency for a CCD in which an image is in sharp focus (line 90), a CCD in which an image is ½ step out of focus (line 91), and a CCD in which an image is one step out of focus (line 92). As seen from line 90 in FIG. 9, the MTF for even a perfectly focussed image departs from 1.0 as the spatial frequency increases, due to diffraction and aberational effects of the optics. However, the MTF values remain high even at high spatial frequencies. When the image sensor is a step out of focus, as shown by line 92, the MTF falls rapidly with increasing spatial frequency until it reaches a point, indicated by region D in FIG. 9, where the MTF value is dominated by interference effects. Thus, DCT coefficients relating to spatial frequencies to the left of region D are useful for calculating σⱼ²-σk². This corresponds to an MTF value of about 0.2 or greater. For an image sensor that is one-half step out of focus, the MTF falls less quickly, but reaches a value below about 0.2 when the spatial frequency reaches about 20 lines/mm, as shown in by line 91.

As shown in FIG. 9, most useful DCT coefficients S_{n,m} are those in which n and m range from 0 to 4, more preferably 0 to 3, provided that n and m are not both 0. The remaining DCT coefficients may be and preferably are disregarded in the calculating the ranges. Once DCT coefficients are selected for use in calculate a range, ratios of corresponding DCT coefficients from each of two image sensors are determined to estimate σⱼ and σₖ, which in turn are used to calculate the range of the object.

It will be noted that due to the relation MTF=exp(−2π²v²σ²), the MTF will be in the desired range of 0.2 or greater when 0.3≧v·σ.

When the preferred color CCDs are used, separate DCT coefficients are preferably generated for each of the colors red, blue and green. Again, each of these DCT coefficients can be used to determine σⱼ²−σₖ² and calculate the range of the object.

Because a number of DCT coefficients are available for each block of pixels, each of which can be used to provide a separate estimate of σⱼ²−σₖ², it is preferred to generate a weighted average of these coefficients and use the weighted average to determine σj²−σₖ² and calculate the range of the object. Alternately, the various values of σⱼ²−σₖ² are determined and these values are weighted to determine a weighted value for σⱼ²−σₖ² that is used to compute a range estimate. Various weighting methods can be used. Weighting by the DCT coefficients themselves is preferred, because the ones for which the scene has high contrast will dominate and these high contrast coefficients are the ones that are most effective for estimating ranges.

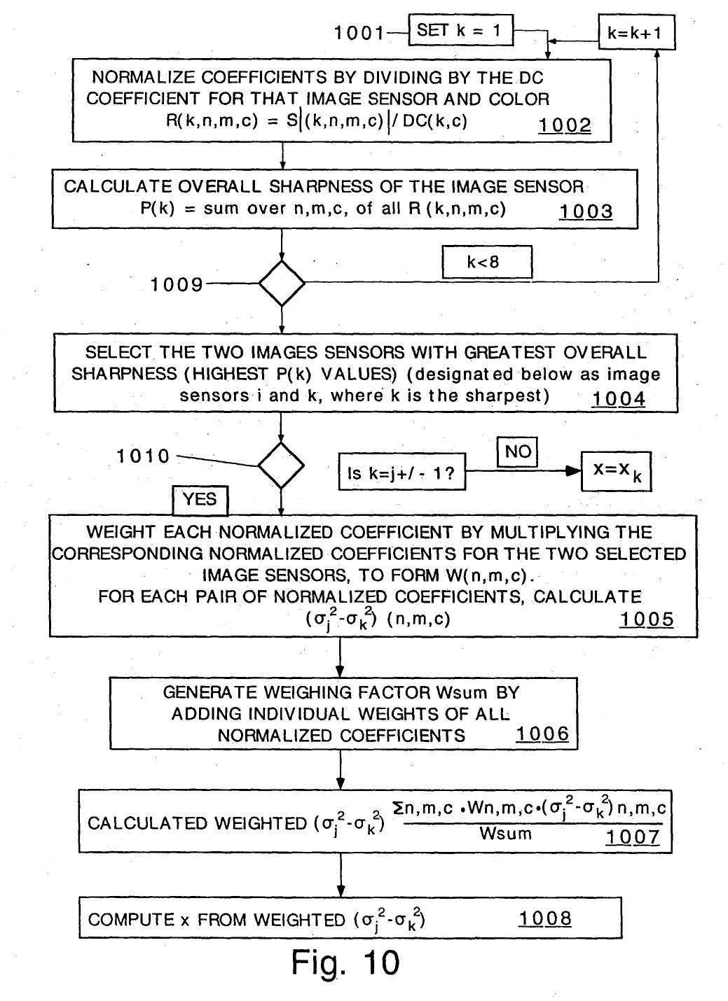

One such weighting method is illustrated in FIG. 10. In FIG. 10, a particular DCT coefficient is represented by the term S(k,n,m,c), where k designates the particular image sensor, n and m designate the spatial frequency (in terms of the DCT matrix) and c represents the color (red, blue or green). In the weighting method in FIG. 10, each of the DCT coefficients for image sensor 1 (k=1) are normalized in block 1002 by dividing it by the absolute value of the DC coefficient for that block of pixels, and that color of pixels (when color CCDs are used). The output of block 1002 is a series of normalized coefficients R(k,n,m,c), where k, n, m and c are as before, each normalized coefficient R representing a particular spatial frequency and color for a particular image sensor k. These normalized coefficients are used in block 1003 to evaluate the overall sharpness of the image on image sensor k, in this case by adding them together to form a total, P(k). Decision block 1009 tests whether the corresponding block in all image sensors has been evaluated; if not, the normalizing and sharpness evaluations of blocks 1002 and 1003 are repeated for all image sensors.

In block 1004, the values of P(k) are compared and used to identify the two image sensors having the greatest overall sharpness. In block 1004, these image sensors are indicated by indices j and k, where k represents that having the sharpest focus. The normalized coefficients for these two image sensors are then sent to block 1005, where they are weighted. Decision block 1010 tests to be sure that the two image sensors identified in block 1004 have consecutive path lengths. If not, a default range x is calculated from the data from image sensor k alone. In block 1005, a weighting factor is developed for each normalized coefficient by multiplying together the normalized coefficients from the two image sensors that correspond to a particular spatial frequency and color. If the weighting factor is nonzero, then σⱼ²−σₖ² is calculated according to equation 7 using the normalized coefficients for that particular spatial frequency and color. If the weighting factor is zero, σⱼ²−σₖ² is set to zero. Thus, the output of block 1005 is a series of calculations of σⱼ²−σk² for each spatial frequency and color.

In block 1006, all of the separate weighting factors are added to form a composite weight. In block 1007, all of the separate calculations of σⱼ²−σₖ² from block 1005 are multiplied by their corresponding weights. These multiples are then added and divided by the composite weight to develop a weighted average calculation of σⱼ²−σₖ². This weighted average calculation is then used in block 1008 to compute the range x of the object imaged in the block of pixels under examination, using equation 4.

By repeating the process for each block of pixels in the image sensors, ranges can be calculated for each object within the field of view of the camera. This information is readily compiled to form a range map.

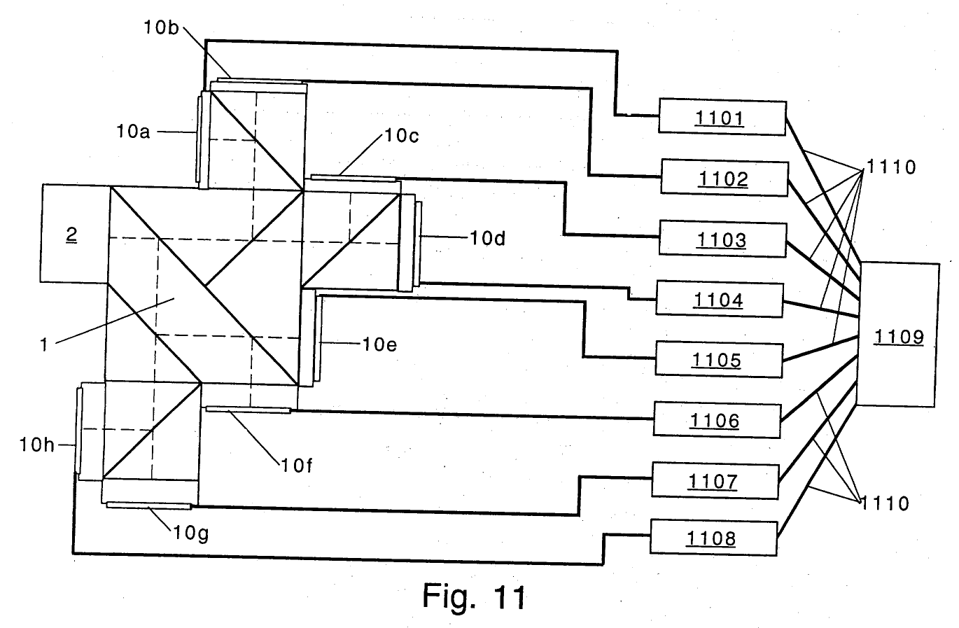

Thus, in a preferred embodiment of the invention, the image sensors provide brightness information to an image processor, which converts that brightness information into a set of signals that can be used to calculate σⱼ²−σₖ² for corresponding blocks of pixels. This arrangement is illustrated in FIG. 11. In FIG. 11, light passes through focussing means 2 and is split into substantially identical images by beamsplitter system 1. The images are projected onto image sensors 10a-10h. Each image sensor is in electrical connection with a corresponding edge connector, whereby brightness information from each pixel is transferred via connections to a corresponding image processor 1101-1108. These connections can be of any type that permits accurate transfer of the brightness information, with analog video lines being satisfactory. The brightness information from each image sensor is converted by image processors 1101-1108 into a set of signals, such as DCT coefficients or other type of signal as discussed before. These signals are then transmitted to computer 1109, such as over high-speed serial digital cables 1110, where ranges are calculated as described before.

If desired, image processors 1101-1108 can be combined with computer 1109 into a single device.

Because a preferred method of generating signals for calculating σⱼ²−σₖ² is a discrete cosine transformation, image processors 1101-1108 are preferably programmed to perform this function. JPEG, MPEG2 and Digital Video processors are particularly suitable for use as the image processors, as those compression methods incorporate DCT calculations. Thus a preferred image processor is a JPEG, MPEG2 or Digital Video processor, or equivalent.

If desired, the image processors may compress the data before sending it to computer 1109, using lossy or lossless compression methods. The range calculation can be performed on the noncompressed data, the compressed data, or the decompressed data. JPEG, MPEG2 and Digital Video processors all use lossy compression techniques. Thus, in an especially-preferred embodiment, each of the image processors is a JPEG, MPEG2 or Digital Video processor and compressed DCT coefficients are generated and sent to computer 1109 for calculation of ranges. Computer 1109 can either use the compressed coefficients to perform the range calculations, or can decompress the coefficients and use the decompressed coefficients instead. However, any Huffman encoding that is performed must be decoded before performing range calculations. It is also possible to use the DCT coefficients generated by the JPEG processor via the DCT without compression.

The method of the invention is suitable for a wide range of applications. In a simple application, the range information can be used to create displays of various forms, in which the range information is converted to visual or audible form. Examples of such displays include, for example:

(a) a visual display of the scene, on which superimposed numerals represent the range of one or more objects in the scene;

(b) a visual display that is color-coded to represent objects of varying distance;

(c) a display that can be actuated, such as, for example, operation of a mouse or keyboard, to display a range value on command;

(d) a synthesized voice indicating the range of one or more objects;

(e) a visual or aural alarm that is created when an object is within a predetermined range.

The range information can be combined with angle information derived from the pixel indices to produce three-dimensional coordinates of selected parts of objects in the images. This can be done with all or substantially all of the blocks of pixels to produce a ‘cloud’ of 3D points, in which each point lies on the surface of some object. Instead of choosing all of the blocks for generating 3D points, it may be useful to select points corresponding to edges. This can be done by selecting those blocks of DCT coefficients with particularly large sum of squares. Alternatively, a standard edge-detection algorithm, such as the Sobel derivative, can be applied to select blocks that contain edges. See, e.g., Petrou et al., Image Processing, The Fundamentals, Wiley, Chichester, England, 1999. In any case, once a group of 3D points has been established, the information can be converted into a file format suitable for 3D computer-aided design (CAD). Such formats include the “Initial Graphics Exchange Specifications” (IGES) and “Drawing Exchange” (DXF) formats. The information can then be exploited for many purposes using commercially available computer hardware and software. For example, it can be used to construct 3D models for virtual reality games and training simulators. It can be used to create graphic animations for, e.g., entertainment, commercials, and expert testimony in legal proceedings. It can be used to establish as-built dimensions of buildings and other structures such as oil refineries. It can be used as topographic information for designing civil engineering projects. A wide range of surveying needs can be served in this manner.

In factory and warehouse settings, it is frequently necessary to measure the locations of objects such as parts and packages in order to control machines that manipulate them. The 3D edge detection and location method described above can be adapted to these purposes. Another factory application is inspection of manufactured items for quality control.

In other applications, the range information is used to control a mobile robot. The range information is fed to the controller of the robotic device, which is operated in response to the range information. An example of a method for controlling a robotic device in response to range information is that described in U.S. Pat. No. 5,793,900 to Nourbakhsh, incorporated herein by reference. Other methods of robotic navigation into which this invention can be incorporated are described in Borenstein et al., Navigating Mobile Robots, A K Peters, Ltd., Wellesley, Mass., 1996. Examples of robotic devices that can be controlled in this way are automated dump trucks, tractors, orchard equipment like sprayers and pickers, vegetable harvesting machines, construction robots, domestic robots, machines to pull weeds and volunteer corn, mine clearing robots, and robots to sort and manipulate hazardous materials.

Another application is in microsurgery, where the range information produced in accordance with the invention is used to guide surgical lasers and other targeted medical devices.

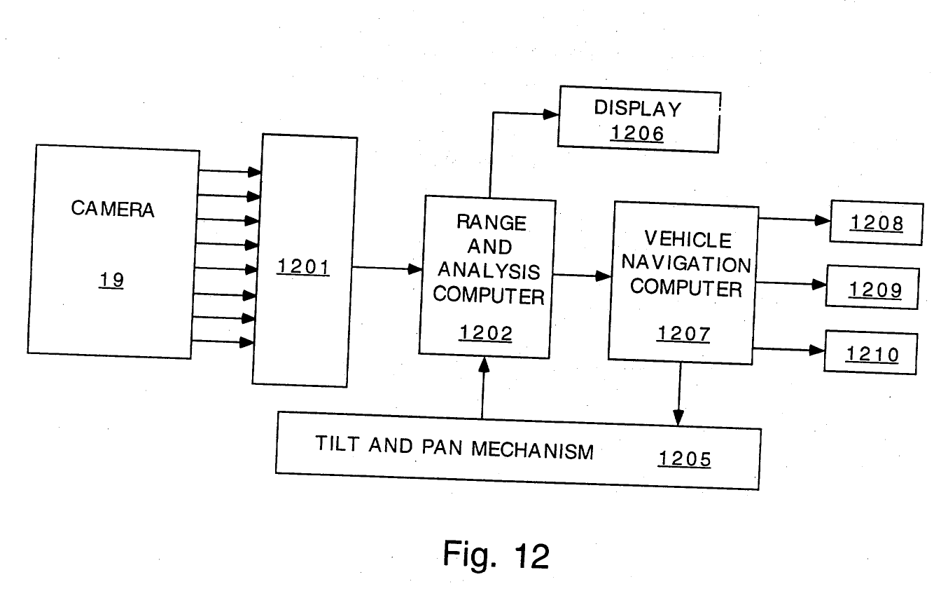

Yet another application is in the automated navigation of vehicles such as automobiles. A substantial body of literature has been developed pertaining to automated vehicle navigation and can be referred to for specific methods and approaches to incorporating the range information provided by this invention into a navigational system. Examples of this literature include Advanced Guided Vehicles, Cameron et al, eds., World Scientific Press, Singapore, 1994; Advances in Control Systems and Signal Processing, Vol. 7: Contributions to Autonomous Mobile Systems, I. Hartman, ed., Vieweg, Braunschweig, Germany 1992; and Vision and Navigation, Thorpe, ed., Kluwer Academic Publishers, Norwell, Mass., 1990. A simplified block diagram of such a navigation system is shown in FIG. 12. In FIG. 12, multiple image sensors on camera 19 send signals over connections to image processors 1201, which generate the focus metrics and forward them to computer 1202 for calculation of ranges. Computer 1202 receives tilt and pan information from tilt and pan mechanism 1205, which it uses to adjust the range calculations in response to the field of view of camera 19 at any given time. Computer 1202 forwards the range information to a display means 1206 and/or vehicle control system 1207. Vehicle navigation computer 1207 operates one or more control mechanisms of the vehicle, including for example, acceleration, braking, or steering, in response to range information provided by computer 1203. Artificial intelligence (AI) software (see, e.g., Dickmans, “Improvements in Visual Autonomous Road Vehicle Guidance 1987-94”, Visual Navigation, From Biological Systems to Unmanned Ground Vehicles, Aloimonos, Ed., Lawrence Erlbaum Associates, Pub., Mahwah, N.J. 1997), is used by vehicle navigation computer 1207 to control camera 19 as well as the vehicle. Operating parameters of camera 19 controlled by vehicle navigation computer 1207 may include the tilt and pan angles, the focal length (zoom) and overall focus distance.

The AI software mimics certain aspects of human thinking in order to construct a “mental” model of the location of the vehicle on the road, the shape of the road ahead and the location and speed of other vehicles, pedestrians, landmarks, etc., on and near the road. Camera 19 provides much of the information needed to create and frequently update this model. The area-based processing can locate and help to classify objects based on colors and textures as well as edges. The MPEG2 algorithm, if used, can provide velocity information for sections of the image that can be used by vehicle navigation computer 1207, in addition to the range and bearing information provided by the invention, to improve the dynamic accuracy of the AI model. Additional inputs into the AI computer might include, for example, speed and mileage information, position sensors for vehicle controls and camera controls, a Global Positioning System receiver, and the like. The AI software should operate the vehicle in a safe and predictable manner, in accordance with the traffic laws, while accomplishing the transportation objective.

Many benefits are possible with this form of driving. These include safety improvements, freeing drivers for more production activities while commuting, increased freedom for people who are otherwise unable to drive due to disability, age or inebriation, and increased capacity of the road system due to a decrease in the required following distance.

Yet another application is the creation of video special effects. The range information generated according to this invention can be used to identify portions of the image in which the imaged objects fall within a certain set of ranges. The portion of the digital stream that represents these portions of the image can be identified by virtue of the calculated ranges and used to replace a portion of the digital stream of some other image. The effect is one of superimposing part of one image over another. For example, a composite image of a broadcaster in front of a remote background can be created by recording the video image of the broadcaster in front of a set, using the camera of the invention. Using the range estimations provided by this invention, portions of the video image that correspond to the broadcaster can be identified because the range of the broadcaster will be different than that of the set. To provide a background, a digital stream of some other background image is separately recorded in digital form. By replacing a portion of the digital stream of the background image with the digital stream corresponding to the image of the broadcaster, a composite image is made which displays the broadcaster seemingly in front of the remote background. It will be readily apparent that the range information can be used in similar manner to create a large number of video special effects.

The method of the invention can also be used to construct images with much larger depth of field than the focus means ordinarily would provide. First, images are collected from each image sensor. For each section of the images, the sharpest and second sharpest images are identified, such as by the method shown in FIG. 10, and these images are used to estimate the distance of the object corresponding to that section of the images. Equation 1 and the relationship σ=D_{B}/1.414 permits the calculation of σ. For each DCT coefficient, the factor in the MTF due to defocus is given by exp(−2π²v²σ²), as described before. To deblur the image, each DCT coefficient is divided by the MTF to provide an estimate the coefficient that would have been measured for a perfectly focused image. The estimated “corrected” coefficients then can be used to create a deblurred image. The corrected image is assembled from the sections of corrected coefficients that are potentially derived from all the source ranges, where the sharpest images are used in each case. If all the objects in the field of view art at distances greater than or equal to the smallest xᵢ or and less than or equal to the largest xᵢ, then the corrected image will be nearly in perfect focus almost everywhere. The only significant departures from perfect focus will be cases where a section of pixels straddles two or more objects that are at very different distances. In such cases at least part of the section will be out of focus. Since the sections of pixels are small (typically 8×8 blocks when the preferred JPEG, MPEG2 or Digital Video algorithms are used to determine a focus metric), this effect should have only a minor impact on the overall appearance of the corrected image.

The invention may be very useful in microscopy, because most microscopes are severely limited in depth of field. In addition, there are purely photographic applications of the invention. For example, the invention permits one to use a long lens to frame a distant subject in a foreground object such as a doorway. The invention permits one to create an image in which the doorway and the subject are both in focus. Note that this can be achieved using a wide aperture, which ordinarily creates a very small depth of field.

In cinematography, a specialist called a focus puller has the job of adjusting the focus setting of the lens during the shot to shift the emphasis from one part of the scene to another. For example, the focus is often thrown back and forth between two actors, one in the foreground and one in the background, according to which one is delivering lines. Another example is follow focus, an example of which is an actor walking toward the camera on a crowded city sidewalk. It is desired to keep the actor in focus as the center of attention of the scene. The work of the focus puller is somewhat hit or miss, and once the scene is put onto film or tape, there is little that can be done to change or sharpen the focus. Conventional editing techniques make it possible to artificially blur portions of the image, but not to make them significantly sharper.

Thus, the invention can be used as a tool to increase creative control by allowing the focus and depth of field to be determined in post-production. These parameters can be controlled by first synthesizing a fully sharp image, as described above, and then computing the appropriate MTF for each part of the image and applying it to the transform coefficients (i.e., DCT coefficients).

It will be appreciated that many modifications can be made to the invention as described herein without departing from the spirit of the invention, the scope of which is defined by the appended claims.

What is claimed is:

1. A camera comprising
(a) a focusing means
(b) multiple image sensors which receive two-dimensional images, said image sensors each being located at different optical path lengths from the focusing means and,
(c) a beamsplitting system for splitting light received though the focusing means into two or more beams and projecting said beams onto multiple image sensors to form multiple, substantially identical images on said image sensors.

2. The camera of claim 1, wherein said image sensors are CMOSs or CCDs.

3. The camera of claim 2, wherein said beamsplitting system projects substantially identical images onto at least three image sensors.

4. The camera of claim 3, wherein said beamsplitting system is a binary cascading system providing n levels of splitting to form 2n substantially identical images.

5. The camera of claim 4, wherein n is 3, and eight substantially identically images are projected onto eight image sensors.

6. The camera of claim 3, wherein said focussing system is a compound lens.

7. The camera of claim 6, wherein said image sensors are each in electrical connection with a JPEG, MPEG2 or Digital Video processor.

8. The camera of claim 7, wherein said JPEG, MPEG2 or Digital Video processors are in electrical connection with a computer programmed to calculate range estimates from output signals from said JPEG, MPEG2 or Digital Video processors.

9. A method for determining the range of an object, comprising
(a) framing the object within the field of view of camera having a focusing means,
(b) splitting light received through and focussed by the focusing means and projecting substantially identical images onto multiple image sensors that are each located at different optical path length from the focusing means,
(c) for at least two of said multiple image sensors, identifying a section of said image corresponding to substantially the same angular sector in object space and that includes at least a portion of said object, and for each of said sections, calculating a focus metric indicative of the degree to which said section of said image is in focus on said image sensor, and
(d) calculating the range of the object from said focus metrics.

10. The method of claim 9 wherein steps (c) and (d) are repeated for multiple sections of said substantially identical images to provide a range map.

11. A beamsplitting system for splitting a focused light beam through n levels of splitting to form multiple, substantially identical images, comprising an arrangement of 2ⁿ-1 beamsplitters which are each capable of splitting a focussed beam of incoming light into two beams, said beamsplitters being hierarchically arranged such that said focussed light beam is divided into 2ⁿ beams, n being an integer of 2 or more.

12. The device of claim 11 wherein said 2n-1 beamsplitting means are each a partially reflective surface oriented diagonally to the direction of the incoming light.

13. The device of claim 12 wherein said partially reflective surface is a surface of a prism which is coated with a hybrid metallic/dielectric partially reflective coating.

14. The device of claim 13 wherein n is 3.

15. The device of claim 14 including means for projecting eight substantially identical images onto eight image sensors.

16. A method for determining the range of one or more imaged objects comprising (a) splitting a focused image into a plurality of substantially identical images and projecting each of said substantially identical images onto a corresponding image sensors having an array of light-sensing pixels, wherein each of said image sensors is located at a different optical path length than the other image sensors;
(b) for each image sensor, identifying a set of pixels that detect a given portion of said focused image, said given portion including at least a portion of said imaged object;
(c) identifying two of said image sensors in which said given portion of said focused image is most nearly in focus;
(d) for each of said two image sensors identified in step c), generating a set of one or more signals that can be compared with one or more corresponding signals from the other of said two image sensors to determine the difference in the squares of the blur diameters of a point on said object;
(e) calculating the difference in the squares of the blur diameters of a point on said object from the signals generated in step d) and
(f) calculating the range of said object from the difference in the squares of the blur diameters.

17. The method of claim 16 wherein steps c, d, e and f are performed using a computer.

18. The method of claim 17 wherein said blur diameters are expressed as widths of a Gaussian brightness function.

19. The method of claim 18 wherein in step d, said signals are generated using a discrete cosine transformation.

20. The method of claim 19 wherein said signals are in JPEG, MPEG2 or Digital Video format.

21. The method of claim 20 wherein for each of said image sensors, a plurality of signals are generated that can be compared with one or more corresponding signals from the other of said two image sensors to determine the difference in the squares of the blur diameters of a point on said object, and the range of said object is determined using a weighted average of said signals.

22. A method for creating a range map of all objects within the view of view of a camera, comprising
(a) framing an object space within the field of view of camera having a focusing means
(b) splitting light received through and focussed by the focusing means and projecting substantially identical images onto multiple image sensors that are each located at a different optical path length from the focusing means,
(c) identifying a section of said image on at least two of said multiple image sensors that correspond to substantially the same angular sector of the object space
(d) for each of said sections, calculating a focus metric indicative of the degree to which said section of said image is in focus on said image sensor,
(e) calculating the range of an object within said angular sector of the object space from said focus metrics, and
(f) repeating steps (c)-(e) for all sections of said images.

23. A method for determining the range of an object, comprising
(a) forming at least two substantially identical images of at least a portion of said object on one or more image sensors, where said substantially identical images are focussed differently;
(b) for sections of said substantially identical images that correspond to substantially the same angular sector in object space and include an image of at least a portion of said object, analyzing the brightness content of each image at one or more spatial frequencies by performing a discrete cosine transformation to calculate a focus metric, and
(c) calculating the range of the object from the focus metrics.
